(19) United States
(12) Patent Application Publication
(10) Pub. No.: US 2022/0122041 A1
(43) Pub. Date: Apr. 21, 2022

(54) MEETING SCHEDULING ASSISTANT

(71) Applicant: ADP, LLC, Roseland, NJ (US)

(72) Inventors: Daiane Cardoso, Porto Alegre (BR); Guilherme Femando Mar, Porto Alegre (BR); Luiz Eduardo Vergara Soares, Porto Alegre (BR); Cristian Basilio, Porto Alegre (BR)

(21) Appl. No.: 17/074,494

(22) Filed: Oct. 19, 2020

(51) Int. Cl. G06Q 10/10; G06Q 10/06

(52) U.S. Cl. CPC G06Q 10/1095; G06Q 10/06314; G06F 3/167; G06Q 10/06312; G06Q 10/06315

(57) ABSTRACT

A system, method, and computer program product for scheduling a meeting and performing other meeting scheduling functions. A request to schedule a meeting is received from an operator along with information identifying requested participants in the meeting, a preferred meeting time for the meeting, and requested resources for the meeting. In response to receiving the request, a meeting room that has capacity for the requested participants, is available during the preferred meeting time, and includes the requested resources for the meeting is automatically identified. A meeting schedule including meeting information identifying the meeting room, a meeting time corresponding to the preferred meeting time, and meeting participants corresponding to the requested participants is automatically generated and sent to the meeting participants.

### BACKGROUND INFORMATION

### 1. Field

The present disclosure relates generally to systems and methods for scheduling meetings. More particularly, the present disclosure relates to a system and method implemented in a computer system for automatically identifying an appropriate meeting room and other resources for a meeting, automatically scheduling the meeting for the identified meeting room and resources, and communicating meeting information for the scheduled meeting to meeting participants.

### 2. Background

Businesses and other organizations may have personnel in operations at various locations. For example, a large business or other organization may have facilities at many different locations throughout a country or even throughout the world. Although physically separated, individuals at these various facilities may need to work together on specific projects or may even form teams that work together on a regular basis. These individuals may also work with individuals at other businesses or organizations, at yet other different locations, on various projects or as part of teams.

The successful completion of a project or successful operation of a team may require meetings of various groups of individuals at various locations in an organization, or in several organizations. These meetings may include regularly scheduled meetings of specific individuals. However, many such meetings will be conducted as needed and will include various different groups of individuals working on a project or in a team, depending upon the business to be conducted at the meeting.

Many meetings may now be conducted entirely via web conferencing, in which each participant attends the meeting individually from their own computer. However, there are advantages to in-person meetings, in which several individuals meet together in a room, and in-person meetings may be required or desirable in some cases. Most organizations maintain meeting rooms that are specifically configured for such meetings. For example, these meeting rooms may be supplied with various resources for conducting a meeting, such as video display equipment, whiteboards, flip charts, and other resources.

For organizations with individuals at various different locations working together on a project or team, a meeting in which groups of individuals in meeting rooms at the different locations are joined together via a videoconference may be most effective. Therefore, appropriate equipment for conducting a videoconference may be provided as another resource in some meeting rooms.

In arranging a meeting, is desirable to take advantage of the various meeting rooms having various different resources for conducting a meeting that may be available. However, arranging a meeting among individuals at various different locations, and given various options for meeting rooms and resource, may be a relatively complex and time-consuming task. The complexity of such a task may increase as the number of participants in the meeting increases.

Accordingly, it would be beneficial to have a method and apparatus that take into account one or more of the issues discussed above as well as possibly other issues.

### SUMMARY

An embodiment of the present disclosure provides a method of scheduling a meeting by a computer system. A request to schedule the meeting and information identifying requested participants in the meeting, a preferred meeting time for the meeting, and requested resources for the meeting are received from an operator. In response to receiving the request to schedule the meeting, the computer system automatically identifies a meeting room that has capacity for the requested participants, is available during the preferred meeting time, and includes the requested resources for the meeting. A meeting schedule including meeting information identifying the meeting room, a meeting time corresponding to the preferred meeting time, and meeting participants corresponding to the requested participants is automatically generated by the computer system and sent to the meeting participants.

Another embodiment of the present disclosure provides an apparatus for scheduling a meeting comprising a user interface generator, a meeting scheduler, and a message handler. The user interface generator is configured to generate a user interface for receiving a request from an operator to schedule the meeting and information identifying requested participants in the meeting, a preferred meeting time for the meeting, and requested resources for the meeting. The meeting scheduler is configured to, in response to receiving the request, identify a meeting room that has capacity for the requested participants, is available during the preferred meeting time, and includes the requested resources for the meeting, and generate a meeting schedule including meeting information identifying the meeting room, a meeting time corresponding to the preferred meeting time, and meeting participants corresponding to the requested participants. The message handler is configured to send the meeting schedule to the meeting participants.

Yet another embodiment of the present disclosure provides a method of performing a meeting scheduling function by a computer system. A request to perform a meeting scheduling function is received from an operator. In response to receiving the request to perform the meeting scheduling function, it is determined whether information for performing the meeting scheduling function has been received. In response to a determination that the information for performing the meeting scheduling function has not been received, the operator is prompted to input the information for performing the meeting scheduling function. The meeting scheduling function is performed by the computer system in response to a determination that the information for performing the meeting scheduling function has been received.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is an illustration of a block diagram of a meeting environment in accordance with an illustrative embodiment;

FIG. 3 is an illustration of a block diagram of a meeting scheduling system in accordance with an illustrative embodiment;

FIG. 4 is an illustration of a block diagram of a user interface for a meeting scheduling assistant in accordance with an illustrative embodiment;

FIG. 5 is an illustration of a block diagram of a meeting scheduling assistant in accordance with an illustrative embodiment;

FIG. 6 is an illustration of a flowchart of a process for operating a meeting scheduling assistant in accordance with an illustrative embodiment;

FIG. 7 is an illustration of a flowchart of a process for scheduling a meeting using a meeting scheduling assistant in accordance with an illustrative embodiment; and

FIG. 8 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that many projects may require meetings of teams that include people at various locations in an organization or in several organizations. For example, participants in such meetings may be located in different parts of a country or in different countries throughout the world.

The illustrative embodiments further recognize and take into account that scheduling a meeting of individuals at various locations may involve many factors, such as the availability of meeting rooms and necessary equipment at the locations, the availability of the various participants, time zone differences at the different locations, among others. Therefore, scheduling such a meeting may be very time-consuming. This problem becomes more noticeable when there is a need for more people to participate in the meeting. Currently, a person responsible for scheduling a meeting may spend a lot of time trying to find the best time for the meeting for all of the participants.

The illustrative embodiments provide an automated meeting scheduling assistant that provides for scheduling a meeting among various participants more quickly than current methods. Illustrative embodiments may be integrated with current electronic calendar or communication tools that are used by individuals at various organizations, thereby allowing any individual to schedule a meeting. In some illustrative embodiments, an operator may use natural language to schedule a meeting using the meeting scheduling assistant.

Illustrative embodiments automatically prompt an operator to provide the information necessary to schedule a meeting. For example, illustrative embodiments may prompt an operator to indicate a preferred date and time and duration for the meeting, to identify the people who are requested to attend the meeting, including indicating whether a requested participant is mandatory or optional, and to identify resources needed for the meeting. The illustrative embodiments then automatically generate an appropriate meeting schedule at an appropriate local time for each participant and in an appropriate meeting room for each of the participants. The meeting schedule may be sent to the participants for approval. Reminders may be sent to the participants when the time for the meeting is near.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A, one of item B, and ten of item C; four of item B and seven of item C; or other suitable combinations.

As used herein, “a number of” when used with reference to items, means one or more items. For example, “a number of different types of networks” is one or more different types of networks.

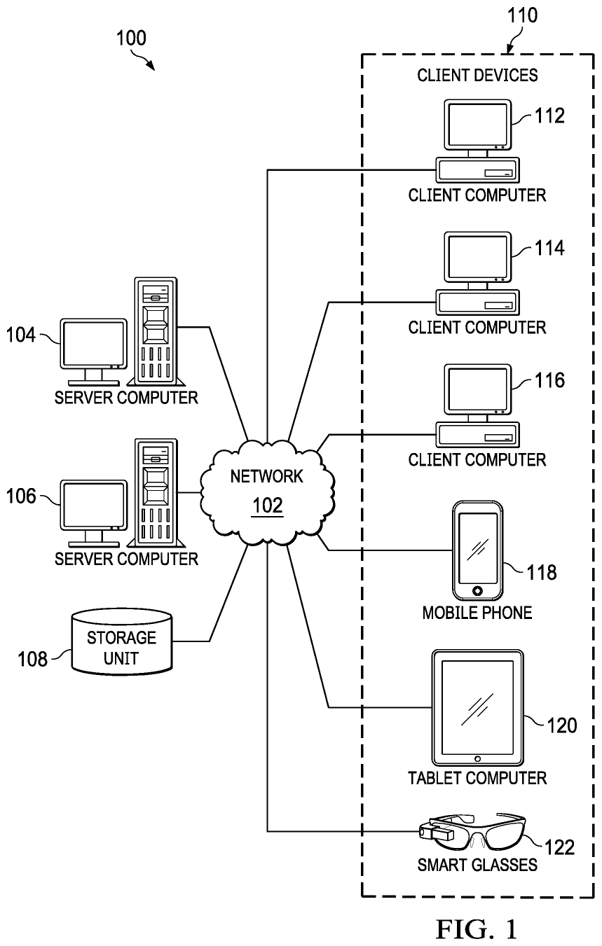

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. As depicted, client devices 110 include client computer 112, client computer 114, and client computer 116. Client devices 110 can be, for example, computers, workstations, or network computers. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, program code can be stored on a computer-recordable storage medium on server computer 104 and downloaded to client devices 110 over network 102 for use on client devices 110.

Network data processing system 100 may be the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

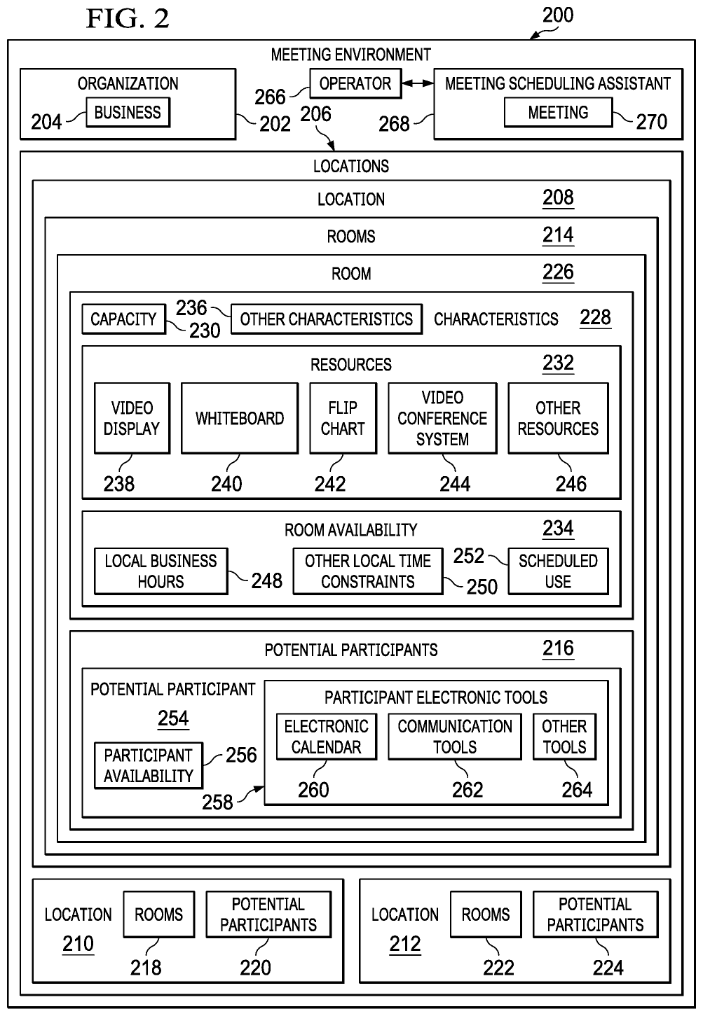

Turning to FIG. 2, an illustration of a block diagram of a meeting environment is depicted in accordance with an illustrative embodiment. Meeting environment 200 may include any environment in which a meeting may take place. Meeting environment 200 may be an environment for meetings of employees or other people associated with organization 202. Organization 202 may be a business 204 or any other appropriate entity. Alternatively, meeting environment 200 may be an environment for meetings of people from several different organizations.

Meeting environment 200 includes a plurality of locations 206. Locations 206 may include different locations throughout a country or throughout the world. For example, without limitation, locations 206 include location 208, location 210, and location 212. A meeting environment may include more or fewer than three locations.

Each of locations 206 may include a number of rooms in which a meeting may be held and a number of potential participants in the meeting. For example, location 208 includes rooms 214 and potential participants 216. Location 210 includes rooms 218 and potential participants 220. Location 212 includes rooms 222 and potential participants 224.

Each room 226 in rooms 214, rooms 218, and rooms 222 comprises an appropriate area for conducting a meeting. Room 226 may be designated as a meeting room, a conference room, or using other appropriate terminology. Room 226 may include a partially enclosed space or an appropriate area for conducting a meeting that is outside of a building or other structure.

Each room 226 has characteristics 228 including capacity 230, resources 232, room availability 234, and other characteristics 236. Capacity 230 is the maximum number of participants that room 226 is configured to hold for a meeting. Capacity 230 may be determined based on the size of room 226, the number of chairs or other seating in room 226, or in any other appropriate manner.

Resources 232 includes any appropriate items or capabilities for a meeting that are available for use in a meeting in room 226. For example, without limitation, resources 232 may include one or more of video display 238, whiteboard 240, flip chart 242, video conference system 244, and other resources 246.

Room availability 234 defines the times during which a meeting may be conducted in room 226. Room availability 234 may be determined by local business hours 248, other local time constraints 250, and scheduled use 252. Local business hours 248 are the typical times that business is conducted at location 208 and room 226 will be available for use. Other local time constraints 250 may include holidays or other events at location 208 that may limit the availability of room 226 for a meeting. Scheduled use 252 includes times when a meeting is already scheduled for room 226 or when room 226 is scheduled for other uses, such as cleaning or repair.

Each potential participant 254 in potential participants 216, potential participants 220, and potential participants 224 is an individual who may be a participant in a meeting. Participant availability 256 is the times at which potential participant 254 may be available to attend a meeting. Potential participant 254 may use various participant electronic tools 258. For example, without limitation, participant electronic tools 258 may include electronic calendar 260, communication tools 262, and other tools 264. For example, participant availability 256 may be determined from information in participant electronic tools 258.

In accordance with an illustrative embodiment, operator 266 may use meeting scheduling assistant 268 to schedule meeting 270 in meeting environment 200. Operator 266 may be any appropriate human operator of meeting scheduling assistant 268. Operator 266 may or may not be a participant in meeting 270 being scheduled using meeting scheduling assistant 268.

The illustration of the different components in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

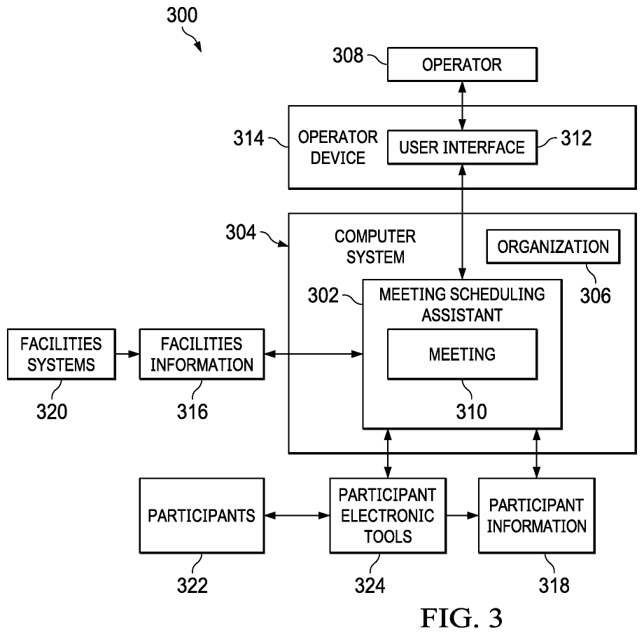

Turning to FIG. 3, an illustration of a block diagram of a meeting scheduling system is depicted in accordance with an illustrative embodiment. Meeting scheduling system 300 may be used, for example, by operator 266 to schedule meeting 270 in meeting environment 200 in FIG. 2. Meeting scheduling system 300 may be implemented in a computer system, such as network data processing system 100 in FIG. 1.

Meeting scheduling system 300 comprises meeting scheduling assistant 302. Meeting scheduling assistant 302 is an example of one implementation of meeting scheduling assistant 268 in FIG. 2.

In this illustrative example, meeting scheduling assistant 302 is implemented using computer system 304. Computer system 304 is a physical hardware system and includes one or more data processing systems. When more than one data processing system is present in computer system 304, those data processing systems are in communication with each other using a communications medium. The communications medium can be a network. The data processing systems can be selected from at least one of a computer, a server computer, a tablet computer, or some other suitable data processing system.

For example, without limitation, meeting scheduling assistant 302 may be implemented in computer system 304 that is operated by or for organization 306. Organization 306 is an example of organization 202 and may be business 204 in FIG. 2 or any other appropriate entity.

Operator 308 may use meeting scheduling assistant 302 to schedule meeting 310. Meeting scheduling assistant 302 may be accessed and used by operator 308 via user interface 312 on operator device 314. Operator 308 may be a human operator. User interface 312 may be implemented in any appropriate manner to allow operator 308 to interact with computer system 304, including meeting scheduling assistant 302. Operator device 314 may include any appropriate device on which user interface 312 may be implemented. For example, without limitation, operator device 314 may be implemented as one of client devices 110 in network data processing system 100 in FIG. 1.

Meeting scheduling assistant 302 is configured to schedule meeting 310 using input received from operator 308 via user interface 312, facilities information 316, and participant information 318. Facilities information 316 includes information about rooms and resources that may be available for meeting 310. Facilities information 316 may be maintained by and received from appropriate facilities systems 320.

Participant information 318 includes information from which the availability of participants 322 to attend meeting 310 may be determined. Participant information 318 may be received from participant electronic tools 324 that are used by participants 322. Meeting scheduling assistant 302 may be configured to update participant information 318 for participants 322 in meeting 310 when meeting 310 is scheduled using meeting scheduling assistant 302 by sending information for meeting 310 to participant electronic tools 324.

The illustration of the different components in FIG. 3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

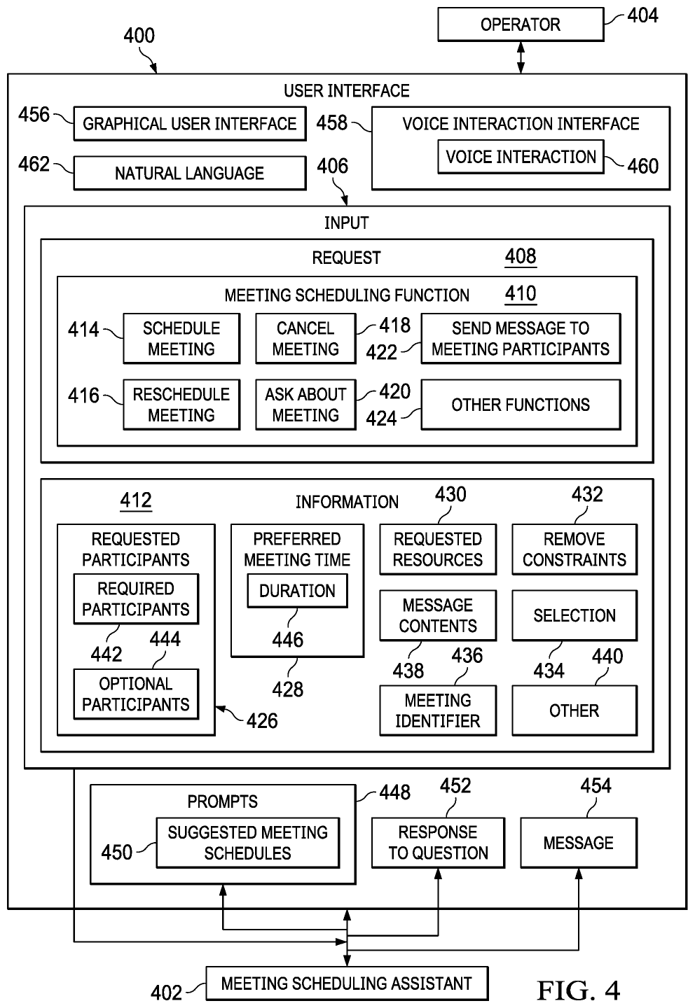

Turning to FIG. 4, an illustration of a block diagram of a user interface for a meeting scheduling assistant is depicted in accordance with an illustrative embodiment. User interface 400 for meeting scheduling assistant 402 is an example of one implementation of user interface 312 for meeting scheduling assistant 302 in FIG. 3.

User interface 400 is configured to allow operator 404 to interact with meeting scheduling assistant 402 to schedule a meeting and perform other related functions. For example, user interface 400 is configured to allow operator 404 to input 406 request 408 to perform meeting scheduling function 410 and information 412 used by meeting scheduling assistant 402 to perform meeting scheduling function 410.

Examples of meeting scheduling function 410 that may be performed by meeting scheduling assistant 402 include, without limitation, schedule meeting 414, reschedule meeting 416, cancel meeting 418, ask about meeting 420, send message to meeting participants 422, and other functions 424. Information 412 used by meeting scheduling assistant 402 to perform meeting scheduling function 410 may include, for example, without limitation, information identifying requested participants 426 in a meeting, preferred meeting time 428 for a meeting, requested resources 430 for a meeting, remove constraints 432, selection 434, meeting identifier 436, message contents 438, and other 440 appropriate information. Requested participants 426 may include required participants 442 and optional participants 444. Preferred meeting time 428 may include one or more blocks of time during which the meeting may take place. Preferred meeting time 428 also may specify a likely or desired duration 446 of the meeting to be scheduled.

Information 412 used by meeting scheduling assistant 402 to perform a particular meeting scheduling function 410 depends on the particular meeting scheduling function 410 to be performed. For example, schedule meeting 414 may require information 412 identifying requested participants 426, preferred meeting time 428, and requested resources 430. For an emergency or other high priority meeting, information 412 may include instructions to remove constraints 432 that otherwise may be applied in scheduling the meeting by meeting scheduling assistant 402. Reschedule meeting 416 may require meeting identifier 436 to identify the meeting to be rescheduled and then the same information as schedule meeting 414 for the rescheduled meeting. Cancel meeting 418 may require meeting identifier 436 to identify the meeting to be canceled. Ask about meeting 420 may require meeting identifier 436 of the meeting asked about. Send message to meeting participants 422 may require meeting identifier 436 for a particular meeting and message contents 438 for the message to be sent to the participants in that meeting.

Information 412 may be provided by operator 404 along with request 408 to perform meeting scheduling function 410. Alternatively, or in addition, user interface 400 may be configured to present prompts 448 to operator 404 to provide any information 412 that is needed from operator 404 to perform a requested meeting scheduling function 410 but that has not yet been provided by operator 404.

Meeting scheduling assistant 402 may generate one or more meeting schedules in response to an operator request 408 to schedule meeting 414 or reschedule meeting 416. In this case, prompts 448 may include one or more suggested meeting schedules 450 for approval or selection by operator 404. Operator 404 input 406 may include selection 434 of one of suggested meeting schedules 450 in response to such prompts 446.

Other information that may be presented to operator 404 on user interface 400 may include response to question 452 in response to meeting scheduling function 410 ask about meeting 420. Message 454 also may be presented to operator 404 on user interface 400. For example, without limitation, message 454 may be a message from another participant in a meeting scheduled by operator 404 using meeting scheduling assistant 402.

User interface 400 may be implemented in any appropriate manner to perform the functions described herein. For example, without limitation, user interface 400 may be implemented as graphical user interface 456 or voice interaction interface 458 or may include the functionality of both graphical user interface 456 and voice interaction interface 458. For graphical user interface 456, operator 404 interacts with user interface 400 via a display device and an input device, such as a mouse, track ball, a touch screen, or the like, for interaction with a displayed interface. For voice interaction interface 458, operator 404 interacts with user interface 400 via voice interaction 460 using a speaker and microphone.

User interface 400 may be configured to provide interaction with operator 404 in natural language 462. Natural language 462 also may be referred to as ordinary language. For example, natural language 462 of operator 404 may be a language that operator 404 uses to interact with other human beings.

Interaction with operator 404 using natural language 462 may be implemented in graphical user interface 456, voice interaction interface 458, or both. Input 406 of request 408 and information 412 by operator 404 and prompts 448 by user interface 400 thus may be made in natural language 462 of operator 404. An example, without limitation, of input 406 by operator and prompts 448 by user interface 400 for meeting scheduling function 410 schedule meeting 414 using natural language 462 is as follows:

Operator: “Schedule a meeting.”

Prompt: “What are your preferred days of the week to schedule your meeting?”

Operator: “Next Monday.”

Prompt: “What are your preferred times for the meeting.”

Operator: “Any time after noon.”

Prompt: “Who do you want to attend the meeting?”

Operator: “Me, Bill, and Sue. All are required.”

Prompt: “What resources are needed for the meeting.”

Operator: “I need a whiteboard or a flip chart.”

The illustration of the different components in FIG. 4 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

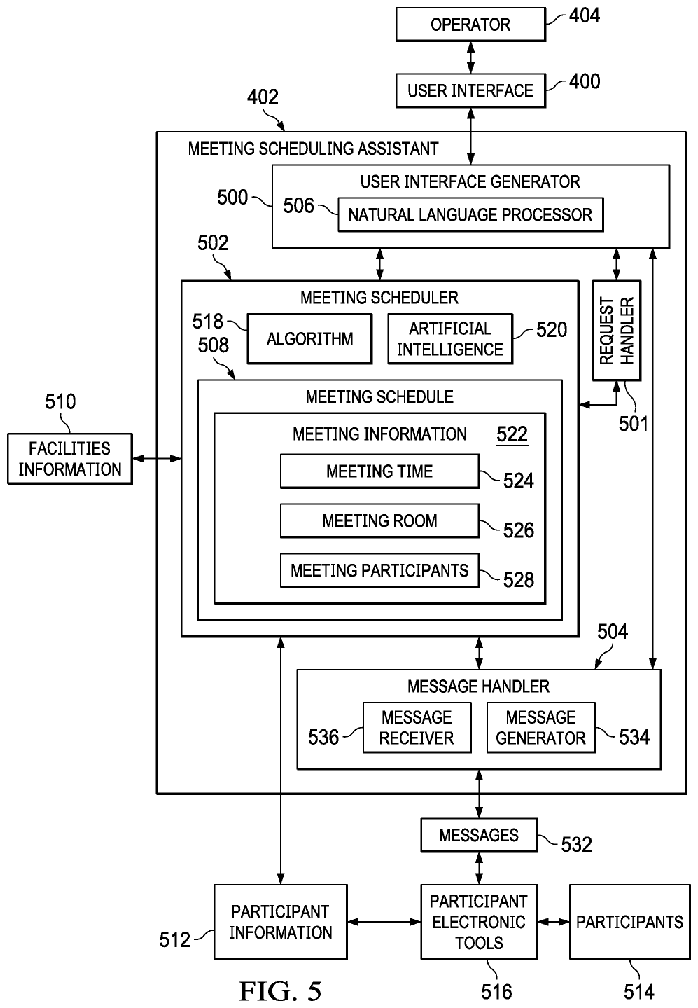

Turning to FIG. 5, an illustration of a block diagram of a meeting scheduling assistant is depicted in accordance with an illustrative embodiment. Meeting scheduling assistant 402 is an example of one implementation of meeting scheduling assistant 402 in FIG. 4. Meeting scheduling assistant 402 includes user interface generator 500, request handler 501, meeting scheduler 502, and message handler 504.

User interface generator 500 is configured to implement the functionality of user interface 400 as described above with reference to FIG. 4. For example, user interface generator 500 may include natural language processor 506 to allow operator 404 to interact with user interface 400 using natural language 462 as described above with reference to FIG. 4.

Request handler 501 is configured to receive and evaluate a request 408 to perform a meeting scheduling function 410 as entered by operator 404 via user interface 400. Request handler 501 is configured to determine whether information 412 needed to perform the requested meeting scheduling function 410 has been provided by operator 404. In response to a determination that information 412 needed to perform the requested meeting scheduling function 410 has not been provided, request handler 501 may instruct user interface generator 500 to generate prompts 448 to obtain the needed information 412 from operator 404. When all of the information 412 needed to perform the requested meeting scheduling function 410 has been received, request handler 501 may initiate performing the requested meeting scheduling function 410. For example, in response to a determination that all of the information 412 needed to perform a requested schedule meeting 414 function has been received, request handler 501 may initiate operation of meeting scheduler 502 to schedule the meeting.

Meeting scheduler 502 is configured to generate meeting schedule 508 from information input by operator 404 via user interface 400, facilities information 510, and participant information 512. Facilities information 510 includes information about rooms and resources that may be available for a meeting. Participant information 512 includes information from which the availability of participants 514 to attend the meeting may be determined. Participant information 512 may be received from participant electronic tools 516 that are used by participants 514.

Meeting scheduler 502 may generate meeting schedule 508 using any appropriate algorithm 518 for identifying a time and room for a meeting that satisfies the requirements for room availability, meeting resources, and participant availability as determined from the information input by operator 404, facilities information 510, and participant information 512. For example, without limitation, algorithm 518 may be trained or otherwise implemented using artificial intelligence 520.

Meeting schedule 506 may be defined by meeting information 522 including meeting time 524, meeting room 526, and meeting participants 528. Meeting time 524 may be defined as a block of time over which the meeting is scheduled to take place. The duration of the meeting is, therefore, included in meeting time 524.

Meeting information 522 may be sent to participants 514 identified as meeting participants 528 in the scheduled meeting to update participant information 512 for participants 514 that are meeting participants 526. Meeting information 522 also may be used to update facilities information 510 for meeting room 526 identified in meeting schedule 508. For example, facilities information 510 may updated to indicate that meeting room 526 is scheduled to be in use during meeting time 524, and thus is not available for another meeting or use during that time.

Messages 532 may be sent between meeting scheduling assistant 402 and participants 514 via message handler 504. Message handler 504 comprises message generator 534 and message receiver 530. Message generator 534 is configured to generate and send messages 532 from meeting scheduling assistant 402 to participants 514. Message receiver 536 is configured to receive messages 532 from participants 514. Message handler 504 may be configured to send and receive messages 532 from participants 514 via any appropriate participant electronic tools 516, such as electronic mail, text messages, and the like.

The illustration of the different components in FIG. 5 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

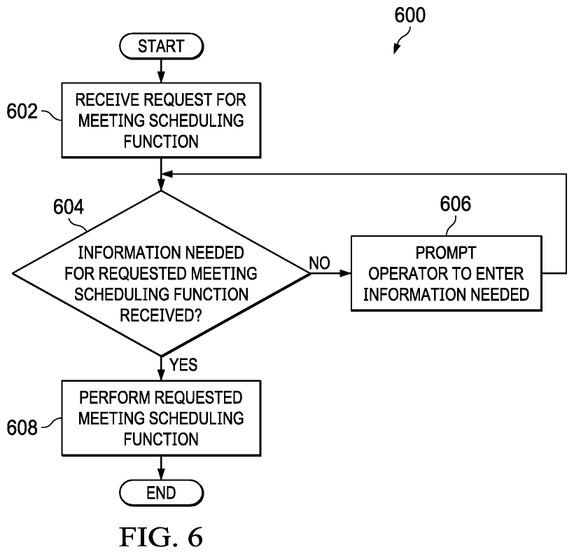

Turning to FIG. 6, an illustration of a flowchart of a process for operating a meeting scheduling assistant is depicted in accordance with an illustrative embodiment. Process 600 may be implemented, for example, in user interface 400 and meeting scheduling assistant 402 in FIG. 4 and FIG. 5.

Process 600 may begin with receiving a request from an operator to perform a meeting scheduling function (operation 602). Information may be needed from the operator to perform the requested meeting scheduling function. It is determined, therefore, whether the information needed for the requested meeting scheduling function has been received (operation 604). In response to a determination at operation 604 that the needed information has not been received, the operator is prompted to enter the information needed (operation 606).

Operations 604 and 606 may be repeated until a determination is made at operation 604 that all of the information needed for the requested meeting scheduling function has been received from the operator. In response to this determination that the information needed has been received, the requested meeting scheduling function may be performed (operation 608), with the process terminating thereafter.

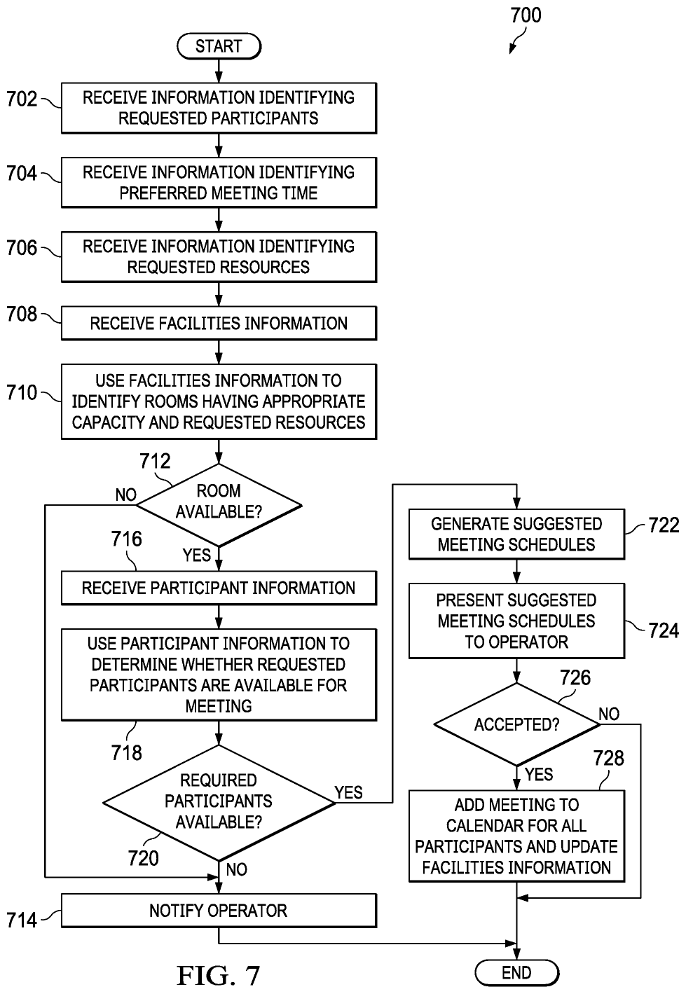

Turning to FIG. 7, an illustration of a flowchart of a process for scheduling a meeting using a meeting scheduling assistant is depicted in accordance with an illustrative embodiment. Process 700 may be implemented, for example, in meeting scheduling assistant 402 in FIG. 4 and FIG. 5.

Process 700 may begin with receiving information identifying requested participants for a meeting (operation 702), receiving information identifying a preferred meeting time for the meeting (operation 704), and receiving information identifying requested resources (operation 706). Operations 702, 704, and 706 may be performed in any order. Some, all, or none of operations 702, 704, and 706 may be performed in response to a prompt to an operator to input the information.

Facilities information then may be received (operation 708). For example, the facilities information may be retrieved from an appropriate facilities system. The facilities information is used to identify rooms that have the appropriate capacity and requested resources (operation 710). It is then determined whether at least one of the rooms identified in operation 710 is available during the preferred meeting time (operation 712). In response to a determination at operation 712 that a room with appropriate capacity and resources is not available at the preferred meeting time, the operator may be notified that the meeting cannot be scheduled as requested (operation 714), with the process terminating thereafter.

In response to a determination at operation 712 that an appropriate room with the requested resources is available, participant information may be received (operation 716). Operation 716 may include retrieving the participant information for the requested participants in the meeting from participant electronic tools, such as electronic calendars. The participant information is used to determine whether the requested participants are available for the meeting at the preferred meeting time (operation 718). It then may be determined whether all of the required participants are available for the meeting (operation 720). In response to a determination at operation 720 that all of the required participants are not available, the operator may be notified that the meeting cannot be scheduled as requested (operation 714), with the process terminating thereafter.

In response to a determination at operation 720 that all of the required participants are available, suggested meeting schedules that satisfy the room, resources, and participant availability requirements are generated (operation 722). One or more suggested meeting schedules may be presented to the operator for selection or approval (operation 724). It is then determined whether the operator accepts one of the suggested meeting schedules (operation 726). In response to a determination at operation 726 that a meeting schedule is accepted, the scheduled meeting may be added to the calendar for all of the meeting participants and the facilities information for the scheduled meeting room may be updated (operation 728), with the process terminating thereafter. In response to a determination at operation 726 that a suggested meeting schedule is not accepted by the operator, the process terminates without a meeting being scheduled.

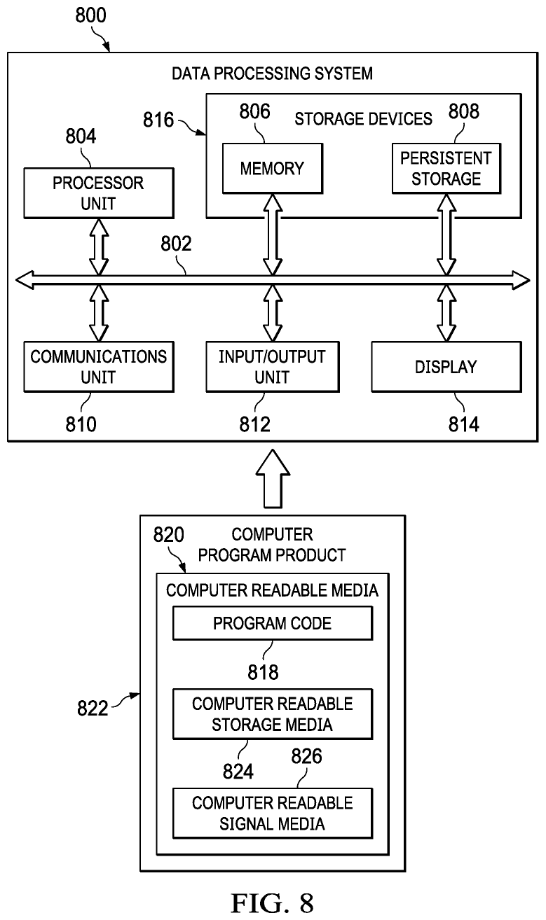

Turning now to FIG. 8, an illustration of a block diagram of a data processing system is depicted in accordance with an illustrative embodiment. Data processing system 800 may be used to implement one or more of server computer 104 in FIG. 1, server computer 106 in FIG. 1, client devices 110 in FIG. 1, computer system 304 in FIG. 3, and operator device 314 in FIG. 3. In this illustrative example, data processing system 800 includes communications framework 802, which provides communications between processor unit 804, memory 806, persistent storage 808, communications unit 810, input/output unit 812, and display 814. In this example, communications framework 802 may take the form of a bus system.

Processor unit 804 serves to execute instructions for software that may be loaded into memory 806. Processor unit 804 may be a number of processors, a multi-processor core, or some other type of processor, depending on the particular implementation. In an embodiment, processor unit 804 comprises one or more conventional general-purpose central processing units (CPUs). In an alternate embodiment, processor unit 804 comprises one or more graphical processing units (CPUs).

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, may be, for example, a random access memory or any other suitable volatile or non-volatile storage device. Persistent storage 808 may take various forms, depending on the particular implementation.

For example, persistent storage 808 may contain one or more components or devices. For example, persistent storage 808 may be a hard drive, a flash memory, a rewritable optical disk, a rewritable magnetic tape, or some combination of the above. The media used by persistent storage 808 also may be removable. For example, a removable hard drive may be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that may be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs may be located in storage devices 816, which are in communication with processor unit 804 through communications framework 802. The processes of the different embodiments may be performed by processor unit 804 using computer-implemented instructions, which may be located in a memory, such as memory 806.

These instructions are referred to as program code, computer-usable program code, or computer-readable program code that may be read and executed by a processor in processor unit 804. The program code in the different embodiments may be embodied on different physical or computer-readable storage media, such as memory 806 or persistent storage 808.

Program code 818 is located in a functional form on computer-readable media 820 that is selectively removable and may be loaded onto or transferred to data processing system 800 for execution by processor unit 804. Program code 818 and computer-readable media 820 form computer program product 822 in these illustrative examples. In one example, computer-readable media 820 may be computer-readable storage media 824 or computer-readable signal media 826.

In these illustrative examples, computer-readable storage media 824 is a physical or tangible storage device used to store program code 818 rather than a medium that propagates or transmits program code 818. Alternatively, program code 818 may be transferred to data processing system 800 using computer-readable signal media 826.

Computer-readable signal media 826 may be, for example, a propagated data signal containing program code 818. For example, computer-readable signal media 826 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

Further, as used herein, “computer-readable media” can be singular or plural. For example, program code 818 can be located in computer-readable media 820 in the form of a single storage device or system. In another example, program code 818 can be located in computer-readable media 820 that is distributed in multiple data processing systems. In other words, some instructions in program code 818 can be located in one data processing system while other instructions in program code 818 can be located in another data processing system. For example, a portion of program code 818 can be located in computer-readable media 820 in a server computer while another portion of program code 818 can be located in computer-readable media 820 located in a set of client computers.

The different components illustrated for data processing system 800 are not meant to provide architectural limitations to the manner in which different embodiments may be implemented. The different illustrative embodiments may be implemented in a data processing system including components in addition to or in place of those illustrated for data processing system 800. Other components shown in FIG. 8 can be varied from the illustrative examples shown. The different embodiments may be implemented using any hardware device or system capable of running program code 818.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added, in addition to the illustrated blocks, in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of scheduling a meeting, comprising:
receiving, by a computer system, a request from an operator to schedule the meeting;
receiving, by the computer system, information identifying requested participants in the meeting, a preferred meeting time for the meeting, and requested resources for the meeting;
in response to receiving the request, identifying, by the computer system, a meeting room that has capacity for the requested participants, is available during the preferred meeting time, and includes the requested resources for the meeting;
generating, by the computer system, a meeting schedule including meeting information identifying the meeting room, a meeting time corresponding to the preferred meeting time, and meeting participants corresponding to the requested participants; and
sending, by the computer system, the meeting schedule to the meeting participants.

2. The method of claim 1, wherein the information identifying the requested participants in the meeting comprises information identifying required participants in the meeting and information identifying optional participants in the meeting.

3. The method of claim 1, wherein the requested resources for the meeting are selected from the group of resources consisting of a video display, a whiteboard, a flip chart, and a video conference system.

4. The method of claim 1, wherein:
identifying the meeting room comprises, receiving facilities information identifying capacity, room availability, and resources for a plurality of rooms and using the facility information to identify the meeting room in the plurality of rooms; and
updating the facility information for the meeting room to identify the meeting time.

5. The method of claim 1 further comprising, in response to receiving the request to schedule the meeting:
determining, by the computer system, whether there is a room that has capacity for the requested participants, is available during the preferred meeting time, and includes the requested resources for the meeting;
in response to a determination that there is not a room that has capacity for the requested participants, is available during the preferred meeting time, and that includes the requested resources for the meeting, notifying, by the computer system, the operator that the meeting cannot be scheduled; and
identifying the meeting room in response to a determination that there is a room that has capacity for the requested participants, is available during the preferred meeting time, and that includes the requested resources for the meeting.

6. The method of claim 1 further comprising, in response to receiving the request to schedule the meeting:
receiving, by the computer system, participant information for the requested participants;
using the participant information to determine, by the computer system, whether the requested participants are available for the meeting;
in response to a determination that the requested participants are not available for the meeting, notifying, by the computer system, the operator that the meeting cannot be scheduled; and
generating and sending the meeting schedule in response to a determination that the requested participants are available for the meeting.

7. The method of claim 1, further comprising, in response to receiving the request to schedule the meeting:
determining, by the computer system, whether the information identifying the requested participants in the meeting, the preferred meeting time for the meeting, or the requested resources for the meeting has been received; and
in response to a determination that the information identifying the requested participants in the meeting, the preferred meeting time for the meeting, or the requested resources for the meeting has not been received, prompting the operator, by the computer system, to input the information identifying the requested participants in the meeting, the preferred meeting time for the meeting, or the requested resources for the meeting.

8. The method of claim 1, wherein receiving the request to schedule the meeting and receiving the information comprises receiving the request to schedule the meeting and the information in a natural language of the operator.

9. The method of claim 1, wherein receiving the request to schedule the meeting and receiving the information comprises receiving the request to schedule the meeting and the information by voice interaction with the operator.

10. An apparatus for scheduling a meeting, comprising:
a user interface generator configured to generate a user interface for receiving a request from an operator to schedule the meeting and information identifying requested participants in the meeting, a preferred meeting time for the meeting, and requested resources for the meeting;
a meeting scheduler configured to, in response to receiving the request:
identify a meeting room that has capacity for the requested participants, is available during the preferred meeting time, and includes the requested resources for the meeting, and
generate a meeting schedule including meeting information identifying the meeting room, a meeting time corresponding to the preferred meeting time, and meeting participants corresponding to the requested participants; and
a message handler configured to send the meeting schedule to the meeting participants.

11. The apparatus of claim 10, wherein the information identifying the requested participants in the meeting comprises information identifying required participants in the meeting and information identifying optional participants in the meeting.

12. The apparatus of claim 10, wherein the requested resources for the meeting are selected from the group of resources consisting of a video display, a whiteboard, a flip chart, and a video conference system.

13. The apparatus of claim 10, wherein the meeting scheduler is configured to:
receive facilities information identifying capacity, room availability, and resources for a plurality of rooms;
use the facilities information to identify the meeting room in the plurality of rooms; and
update the facility information for the meeting room to identify the meeting time.

14. The apparatus of claim 10, wherein the meeting scheduler is further configured to, in response to receiving the request to schedule the meeting:
determine whether there is a room that has capacity for the requested participants, is available during the preferred meeting time, and includes the requested resources for the meeting;
in response to a determination that there is not a room that has capacity for the requested participants, is available during the preferred meeting time, and that includes the requested resources for the meeting, notify the operator that the meeting cannot be scheduled; and
identify the meeting room in response to a determination that there is a room that has capacity for the requested participants, is available during the preferred meeting time, and that includes the requested resources for the meeting.

15. The apparatus of claim 10, wherein the meeting scheduler is further configured to, in response to receiving the request to schedule the meeting:
receive participant information for the requested participants;
use the participant information to determine whether the requested participants are available for the meeting;
in response to a determination that the requested participants are not available for the meeting, notify the operator that the meeting cannot be scheduled; and
generate the meeting schedule in response to a determination that the requested participants are available for the meeting.

16. The apparatus of claim 10, wherein:
the meeting scheduler is configured to, in response to receiving the request to schedule the meeting, determine whether the information identifying the requested participants in the meeting, the preferred meeting time for the meeting, or the requested resources for the meeting has not been received; and
the user interface generator is configured to, in response to a determination that the information identifying the requested participants in the meeting, the preferred meeting time for the meeting, or the requested resources for the meeting has not been received, prompt the operator to input the information identifying the requested participants in the meeting, the preferred meeting time for the meeting, or the requested resources for the meeting.

17. The apparatus of claim 10, wherein the user interface is a natural language user interface.

18. The apparatus of claim 10, wherein the user interface is a voice interaction interface.

19. A computer program product for scheduling a meeting, the computer program product comprising a computer readable storage medium having program instructions embodied therewith, the program instructions executable by a device to cause the device to:
receive a request from an operator to schedule the meeting;
receive information identifying requested participants in the meeting, a preferred meeting time for the meeting, and requested resources for the meeting;
in response to receiving the request, identify a meeting room that has capacity for the requested participants, is available during the preferred meeting time, and includes the requested resources for the meeting;
generate a meeting schedule including meeting information identifying the meeting room, a meeting time corresponding to the preferred meeting time, and meeting participants corresponding to the requested participants; and
send the meeting schedule to the meeting participants.

20. The computer program product of claim 19, wherein the information identifying the requested participants in the meeting comprises information identifying required participants in the meeting and information identifying optional participants in the meeting.

21. The computer program product of claim 19, wherein the requested resources for the meeting are selected from the group of resources consisting of a video display, a whiteboard, a flip chart, and a video conference system.

22. The computer program product of claim 19, wherein the program instructions are executable by the device to cause the device to:
identify the meeting room by receiving facilities information identifying capacity, room availability, and resources for a plurality of rooms and using the facility information to identify the meeting room in the plurality of rooms; and
update the facility information for the meeting room to identify the meeting time.

23. The computer program product of claim 19, wherein the program instructions are executable by the device to cause the device to, in response to receiving the request to schedule the meeting:
determine whether there is a room that has capacity for the requested participants, is available during the preferred meeting time, and includes the requested resources for the meeting;
in response to a determination that there is not a room that has capacity for the requested participants, is available during the preferred meeting time, and that includes the requested resources for the meeting, notify the operator that the meeting cannot be scheduled; and
identify the meeting room in response to a determination that there is a room that has capacity for the requested participants, is available during the preferred meeting time, and that includes the requested resources for the meeting.

24. The computer program product of claim 19, wherein the program instructions are executable by the device to cause the device to, in response to receiving the request to schedule the meeting:
receive participant information for the requested participants;
use the participant information to determine whether the requested participants are available for the meeting;
in response to a determination that the requested participants are not available for the meeting, notify the operator that the meeting cannot be scheduled; and
generate and send the meeting schedule in response to a determination that the requested participants are available for the meeting.

25. The computer program product of claim 19, wherein the program instructions are executable by the device to cause the device to, in response to receiving the request to schedule the meeting:
determine whether the information identifying the requested participants in the meeting, the preferred meeting time for the meeting, or the requested resources for the meeting has been received; and
in response to a determination that the information identifying the requested participants in the meeting, the preferred meeting time for the meeting, or the requested resources for the meeting has not been received, prompt the operator to input the information identifying the requested participants in the meeting, the preferred meeting time for the meeting, or the requested resources for the meeting.

26. The computer program product of claim 19, wherein the program instructions are executable by the device to cause the device to receive the request to schedule the meeting and the information in a natural language of the operator.

27. The computer program product of claim 19, wherein the program instructions are executable by the device to cause the device to receive the request to schedule the meeting and the information by voice interaction with the operator.

28. A method of performing a meeting scheduling function, comprising:
receiving, by a computer system, a request from an operator to perform a meeting scheduling function;
in response to receiving the request to perform the meeting scheduling function, determining, by the computer system, whether information for performing the meeting scheduling function has been received;
in response to a determination that the information for performing the meeting scheduling function has not been received, prompting the operator, by the computer system, to input the information for performing the meeting scheduling function; and
in response to a determination that the information for performing the meeting scheduling function has been received, performing the meeting scheduling function by the computer system.

29. The method of claim 28, wherein the meeting scheduling function is selected from scheduling a meeting, rescheduling a meeting, canceling a meeting, asking about a meeting, or sending a message to meeting participants.

30. The method of claim 28, wherein receiving the request to perform the meeting scheduling function and prompting the operator to input the information comprises receiving the request to perform the meeting scheduling function and prompting the operator to input the information in a natural language of the operator.

31. An apparatus for performing a meeting scheduling function, comprising:
a request handler configured to, in response to receiving a request to perform a meeting scheduling function, determine whether information for performing the meeting scheduling function has been received; and
a user interface generator configured to generate a user interface for receiving the request to perform a meeting scheduling function from an operator and, in response to a determination that the information for performing the meeting scheduling function has not been received, prompting the operator to input the information for performing the meeting scheduling function.

32. The apparatus of claim 31, wherein the meeting scheduling function is selected from scheduling a meeting, rescheduling a meeting, canceling a meeting, asking about a meeting, or sending a message to meeting participants.

33. The apparatus of claim 31, wherein the user interface generator is configured to receive the request to perform the meeting scheduling function and prompt the operator to input the information in a natural language of the operator.
